(19) United States
(12) Patent Application Publication
(10) Pub. No.: US 2026/0155100 A1
(43) Pub. Date: Jun. 4, 2026

(54) DISPLAY PANEL AND DISPLAY DEVICE INCLUDING THE SAME

(71) Applicant: LG Display Co., Ltd., Seoul (KR)

(72) Inventors: Jeong Hwan KIM, Paju-si (KR); Sang Hee YU, Paju-si (KR)

(73) Assignee: LG Display Co., Ltd., Seoul (KR)

(21) Appl. No.: 19/337,178

(22) Filed: Sep. 23, 2025

(30) Foreign Application Priority Data
Nov. 29, 2024 (KR) 10-2024-0174501

(51) Int. Cl. G09G 3/3233; G09G 3/32

(52) U.S. Cl. CPC G09G 3/3233; G09G 3/32; G09G 2300/0413; G09G 2330/021; G09G 2330/10

(57) ABSTRACT

Disclosed is a display panel and a display device including the same. The display panel includes: a display area in which a plurality of sub-pixels, each including a pixel circuit connected to a light-emitting element, are arranged; a non-display area in which a plurality of dummy pixels, each including a dummy pixel circuit, are arranged; at least one repair line extending across the display area and the non-display area; and a first compensation capacitor connected between the repair line and an anode electrode of the light-emitting element.

### CROSS-REFERENCE TO RELATED APPLICATION

This application claims priority to and the benefit of Korean Patent Application No. 10-2024-0174501, filed Nov. 29, 2024, the disclosure of which is incorporated herein by reference in its entirety.

### BACKGROUND

### Technical Field

The present disclosure relates to a display panel and a display device including the same.

### Description of the Related Art

An electroluminescent display device includes self-emissive light-emitting elements, for example, organic light emitting diodes (OLEDs), which are arranged in respective sub-pixels, and has advantages of fast response speed, high luminous efficiency, high luminance, and a wide viewing angle. The electroluminescent display device not only has a fast response speed and excellent luminous efficiency, luminance, and viewing angle, but also can represent black gradation as complete black, and thus has excellent contrast ratio and color reproduction rate. Such an electroluminescent display device does not require a backlight unit and may be implemented on a plastic substrate, a thin glass substrate, and a metal substrate that are flexible materials.

According to a pixel structure of the electroluminescent display device, luminance of pixels may vary. For example, when the luminance of the pixels is low, the luminance may vary sensitively depending on temperature.

### BRIEF SUMMARY

The present disclosure provides a display panel capable of improving image quality, and a display device including the same.

The features of the present disclosure are not limited to those described above, and other features not explicitly mentioned will be clearly understood by those skilled in the art from the description herein.

A display panel according to one embodiment includes: a display area in which a plurality of sub-pixels, each including a pixel circuit connected to a light-emitting element, are arranged; a non-display area in which a plurality of dummy pixels, each including a dummy pixel circuit, are arranged; at least one repair line extending across the display area and the non-display area; and a first compensation capacitor connected between the repair line and an anode electrode of the light-emitting element.

The pixel circuit arranged in the display area may include a diode connection-based internal compensation circuit or a source follower-based internal compensation circuit.

The pixel circuit of each of the sub-pixels arranged in the display area may include: a driving transistor including a first electrode connected to a first node of the sub-pixel, a gate electrode connected to a second node of the sub-pixel, and a second electrode connected to a third node of the sub-pixel; a first switch transistor connected between a constant voltage node to which a reference voltage is applied and the second node of the sub-pixel, and turned on in response to a second scan signal; a second switch transistor connected between a constant voltage node to which an anode reset voltage is applied and a fourth node of the sub-pixel, and turned on in response to a third scan signal; a third switch transistor connected between a data line to which a data voltage is applied and the second node of the sub-pixel, and turned on in response to a first scan signal; a fourth switch transistor connected between a constant voltage node to which a pixel driving voltage is applied and the first node of the sub-pixel, and turned on in response to a first emission signal; and a fifth switch transistor connected between the third node of the sub-pixel and the fourth node of the sub-pixel, and turned on in response to a second emission signal.

The pixel circuit of each of the sub-pixels arranged in the display area may further include: a first capacitor connected between the second node of the sub-pixel and the third node of the sub-pixel; and a second capacitor connected between the constant voltage node to which the pixel driving voltage is applied and the third node of the sub-pixel. The anode electrode of the light-emitting element may be connected to the fourth node of the sub-pixel, and a cathode electrode of the light-emitting element may be connected to a constant voltage node to which a pixel ground voltage is applied.

The dummy pixel circuit may include: a driving transistor of the dummy pixel including a first electrode connected to a first node of the dummy pixel to which the pixel driving voltage is applied, a gate electrode connected to a second node of the dummy pixel, and a second electrode connected to a third node of the dummy pixel; a first switch transistor of the dummy pixel connected between the constant voltage node to which the reference voltage is applied and the second node of the dummy pixel, and turned on in response to the second scan signal; a second switch transistor of the dummy pixel connected between the constant voltage node to which the anode reset voltage is applied and a fourth node of the dummy pixel, and turned on in response to the third scan signal; a third switch transistor of the dummy pixel connected between a dummy data line and the second node of the dummy pixel, and turned on in response to the first scan signal; and a fourth switch transistor of the dummy pixel connected between the third node of the dummy pixel and the fourth node of the dummy pixel, and turned on in response to the second emission signal.

The dummy pixel circuit may further include: a first capacitor of the dummy pixel connected between the second node of the dummy pixel and the third node of the dummy pixel; and a second capacitor of the dummy pixel connected between the first node of the dummy pixel and the third node of the dummy pixel.

The dummy pixel may further include: a light-emitting element of the dummy pixel connected between the fourth node of the dummy pixel and a constant voltage node to which a pixel ground voltage is applied.

The dummy pixel circuit may further include: a second compensation capacitor connected between a gate line to which the first emission signal is applied and the fourth node of the dummy pixel. Optionally, the capacitance of the second compensation capacitor CB may be 10% to 100% of the capacitance of the first capacitor.

The repair line may be connected to the fourth node of the dummy pixel. The first compensation capacitor may be connected between the repair line and the fourth node of the sub-pixel.

A maximum voltage of the data voltage may be applied to the dummy data line.

The display area may include a second sub-pixel. A pixel circuit of the second sub-pixel may be electrically disconnected from an anode electrode of a light-emitting element arranged in the second sub-pixel. The anode electrode of the light-emitting element arranged in the second sub-pixel may be connected to the repair line.

One of a maximum voltage of the data voltage, a data voltage to be applied to the second sub-pixel, and a preset voltage may be applied to the dummy data line.

A display device according to one embodiment includes: a display panel including a display area in which a plurality of sub-pixels, each including a pixel circuit connected to a light-emitting element, are arranged, a non-display area in which a plurality of dummy pixels, each including a dummy pixel circuit, are arranged, at least one repair line extending across the display area and the non-display area, and a first compensation capacitor connected between the repair line and an anode electrode of the light-emitting element; and a display panel driving circuit configured to drive the sub-pixels and the dummy pixel.

The display panel may further include: a plurality of data lines connected to the sub-pixels, a dummy data line connected to the dummy pixel, a plurality of gate lines intersecting the data lines and the dummy data line, and a plurality of power lines connected to the sub-pixels and the dummy pixel. The sub-pixels and the dummy pixel may share the gate lines and the power lines.

The display panel driving circuit may include: a gate driving circuit arranged in the non-display area of the display panel and configured to supply a gate signal to the gate lines; and a data driving circuit configured to supply a data voltage to the data lines and the dummy data line.

The present disclosure may reduce power consumption without degrading image quality, and may improve temperature luminous sensitivity (TLS) characteristics of pixels by rapidly charging an anode electrode of a light-emitting element using a dummy pixel. As a result, the present disclosure may enhance image quality.

The present disclosure may optimize the process and improve the yield of a display panel by enabling a defective sub-pixel to be normally driven through the use of a dummy pixel.

The effects of the present disclosure are not limited to those described above, and other effects not explicitly mentioned will be clearly understood by those skilled in the art from the description of the claims.

### BRIEF DESCRIPTION OF THE SEVERAL VIEWS OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to one embodiment of the present disclosure;

FIG. 2 is a diagram illustrating an example of a repair line;

FIGS. 3A and 3B are diagrams for explaining a comparison of TLS characteristics between an embodiment of the present disclosure and a comparative example;

FIG. 4 is a circuit diagram illustrating a pixel circuit in a display area according to one embodiment of the present disclosure;

FIG. 5 is a circuit diagram illustrating a pixel circuit in a display area according to another embodiment of the present disclosure;

FIG. 6 is a circuit diagram illustrating a pixel circuit of a dummy pixel according to one embodiment of the present disclosure;

FIG. 7 is a circuit diagram illustrating a pixel circuit of a dummy pixel according to another embodiment of the present disclosure;

FIG. 8 is a circuit diagram illustrating an example in which the pixel circuit shown in FIG. 6 is electrically connected to the pixel circuit shown in FIG. 4 through a repair line and a capacitor;

FIG. 9 is a circuit diagram illustrating an example in which the pixel circuit shown in FIG. 7 is electrically connected to the pixel circuit shown in FIG. 4 through a repair line and a capacitor;

FIG. 10 is a circuit diagram illustrating an example in which the pixel circuit shown in FIG. 7 is electrically connected to the pixel circuit shown in FIG. 5 through a repair line and a capacitor;

FIG. 11 is a waveform diagram illustrating gate signals applied to the pixel circuits shown in FIG. 8 and voltages of major nodes;

FIG. 12 is a waveform diagram illustrating gate signals applied to the pixel circuits shown in FIG. 9 and voltages of major nodes;

FIG. 13 is a circuit diagram illustrating an example in which a defective sub-pixel is connected to a dummy pixel through a repair line together with the pixel circuits shown in FIG. 8; and

FIG. 14 is a circuit diagram illustrating an example in which a defective sub-pixel is connected to a dummy pixel through a repair line together with the pixel circuits shown in FIG. 9.

### DETAILED DESCRIPTION

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” “having,” and “consist of” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after,” “following,” “next to,” “before,” or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

The pixel circuit and the gate drive circuit of the display device may include a plurality of transistors. The transistor may be implemented as a thin film transistor (TFT). The transistors may be implemented as an oxide thin film transistor (Oxide TFT) including an oxide semiconductor, a low temperature poly silicon TFT (LTPS TFT) including a low temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor, since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage VGH, and the gate-off voltage may be a gate low voltage VGL. In the case of a p-channel transistor, the gate-on voltage may be the gate low voltage VGL, and the gate-off voltage may be the gate high voltage VGH.

Hereinafter, various embodiments of the present disclosure will be described in detail with reference to the accompanying drawings.

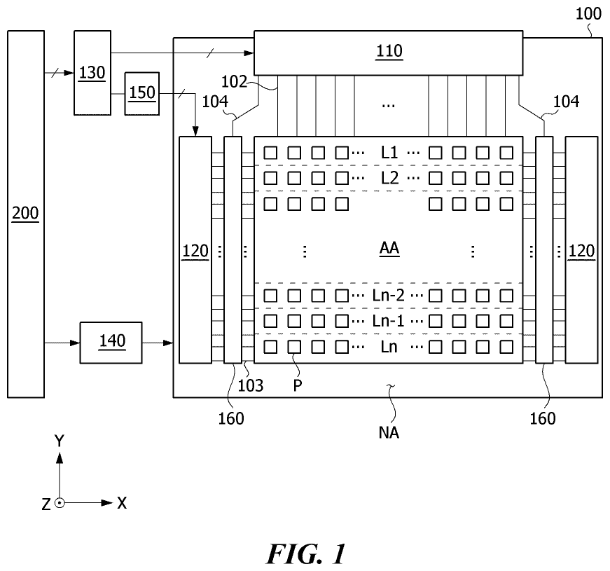

FIG. 1 is a block diagram illustrating a display device according to an embodiment of the present disclosure.

Referring to FIG. 1, the display device according to one embodiment of the present disclosure includes a display panel 100, display panel driving circuits, including a data driver 110 and a gate driver 120, for writing image data to pixels P of the display panel 100, and a power circuit 140 for generating power necessary for driving the pixels P and the display panel driving circuits.

The display panel 100 may be, but is not limited to, a rectangular shaped panel having a width in the X-axis direction (first direction), a length in the Y-axis direction (second direction), and a thickness in the Z-axis direction (third direction). For example, at least a portion of the display panel 100 may have a curved outer periphery. The display panel 100 may be implemented as a non-transmissive display panel or a transmissive display panel. The transmissive display panel may be applied to a transparent display device in which an image is displayed on a screen and an actual object in the background is visible. The display panel 100 may be implemented as a flexible display panel.

The panel 100 may include a display area AA and a non-display area NA outside the display area AA. A display area AA of the display panel 100 may include a pixel array for displaying images thereon. The pixel array may include a plurality of data lines 102, a plurality of gate lines 103 intersecting the data lines 102, and the pixels P arranged in a matrix form. The non-display area NA may further include dummy pixels 160, and dummy data lines 104 connecting dummy channels of the data driver 110 to the dummy pixels 160. The gate lines 103 intersect dummy data lines 104. The display panel 100 may further include a plurality of power lines connected in common to the pixel circuits of the pixels P and the pixel circuits of the dummy pixels 160. Each of the power lines contains a constant voltage node connected to the pixel circuit.

The pixels P may include two or more sub-pixels for color implementation. For example, each of the pixels P may be divided into a red sub-pixel, a green sub-pixel, and a blue sub-pixel. Each of the pixels P may further include a white sub-pixel. Each sub-pixel includes a pixel circuit for driving a light-emitting element.

Each of the sub-pixels of the pixels P may be connected to the data line 102, the gate line 103, and the power line. The dummy pixels 160 may be connected to the dummy data lines 104, the gate lines 103, and the power lines.

The pixel array of the display area AA may include a plurality of pixel lines L1 to Ln. Each of the pixel lines L1 to Ln may include one line of the pixels P arranged along the X-axis direction in the pixel array of the display panel 100. The pixels P arranged in one pixel line may share the gate lines 103. The pixels arranged along the column direction (Y-axis direction) along a data line direction may share the data lines 102. One horizontal period is a time obtained by dividing one frame period by the total number of the pixel lines L1 to Ln.

The dummy pixels 160 may be disposed between the pixels P of the display area AA and the gate driver 120 in the non-display area NA of the display panel 100. The dummy pixels 160 may include a plurality of dummy pixel circuits arranged in the non-display area NA to correspond to the pixel lines L1 to Ln. For example, a first dummy pixel circuit may be disposed in the non-display area NA on an extension line of the first pixel line L1. A pixel circuit of a second dummy pixel may be disposed in the non-display area NA on the extension line of the second pixel line L2. The dummy data line 104 is connected to a dummy channel of the data driver 110 to apply the data voltage output from the dummy channel to the dummy pixel circuit.

The driving circuits (including the data driver 110 and the gate driver 120) of the display panel 100 write pixel data of the input image to the pixels under the control of the timing controller 130.

The timing controller 130 may receive the pixel data of the input image, and a timing signal synchronized with the pixel data from the host system 200. The timing signal may include a vertical synchronization signal Vsync, a horizontal synchronization signal Hsync, a main clock CLK, and a data enable signal DE. One cycle of the vertical synchronization signal Vsync may be a period of one frame. One cycle of the horizontal synchronization signal Hsync and the data enable signal DE may be one horizontal period 1H. The pulse of the data enable signal DE may be synchronized with one line of data to be written to the pixels P on one pixel line. Since a frame period and a horizontal period may be known by counting the data enable signal DE, the vertical synchronization signal Vsync and the horizontal synchronization signal Hsync may be omitted. The timing controller 130 may transmit the pixel data of the input image to the data driver 110 and control the operation timing of the data driver 110 and the gate driver 120. A gate timing control signal generated from the timing controller 130 may be input to the gate driver 120 through a level shifter 150.

The level shifter 150 may receive the gate timing control signal to output a start pulse and a shift clock. An input signal to the level shifter 150 may be a signal of a digital signal voltage level, and an output signal from the level shifter 150 may be an analog voltage signal that swings between a gate high voltage VGH and a gate low voltage VGL. The level shifter 150 may convert a low level voltage of the gate timing signal output from the timing controller 130 to the gate low voltage (VGL) and a high level voltage to the gate high voltage (VGH).

The data driver 110 may receive pixel data of the input image received as a digital signal from the timing controller 130 and output a data voltage. The data driver 110 may convert the pixel data of the input image into a gamma-compensated voltage using a digital-to-analog converter, hereinafter referred to as “DAC,” and output the data voltage. A gamma reference voltage output from the power circuit 140 may be divided into the gamma compensated voltage for each grayscale by a voltage divider circuit in the data driver 110 and supplied to the DAC. The DAC may generate the data voltage as the gamma compensated voltage corresponding to the grayscale value of the pixel data. The data voltage from the DAC may be output to the data line 102 and the dummy data line 104 through an output buffer from the respective channels of the data driver 110. The data voltage output from the data driver 110 may vary depending on the grayscale value of the pixel data. The data voltage may be determined according to the pixel data within a dynamic range between a highest voltage and a lowest voltage that are determined based on the gamma reference voltages.

The circuit of the data driver 110 may be integrated into a drive IC (Integrated Circuit). The drive IC may be bonded to the display panel 100 using a chip on glass (COG) process, or it may be implemented as a chip on film (COF) and bonded to the display panel 100 and electrically connected to the data lines 102 and 104.

The gate driver 120 may be disposed on the display panel 100. The gate driver 120 may be disposed in the non-display area NA outside the display area AA in the display panel 100, or it may be partially disposed in the display area AA. The gate driver 120 may supply a gate signal to the gate lines 103 in a single feeding method. In the single feeding method, the gate signal may be applied at one ends of the gate lines 103. In a double feeding method, the gate signal may be applied simultaneously at opposite ends of the gate lines 103. The gate signal output from the gate driver 120 may be applied to the pixels P of the display area AA and the dummy pixels 160 of the non-display area NA.

A plurality of gate signals may be applied to the pixel circuits of the pixels P and the dummy pixels 160. In this case, a plurality of gate lines 103 are connected to the pixel circuit so that gate signals of different waveforms can be applied. The gate driver 120 may include a plurality of gate drivers that output different gate signals. Each of the gate drivers may include circuits such as a shift register, an edge trigger, and the like to shift the pulses of the gate signals.

The power circuit 140 may include, but is not limited to, a charge pump, a regulator, a buck converter, a boost converter, and the like. The power circuit 140 may receive a direct current input voltage from the host system 200 to generate the power to drive the driving circuits (including the data driver 110 and the gate driver 120) of the display panel 100 and the pixels P of the display panel 100. The power circuit 140 may output a constant voltage (or DC voltage), such as the gamma reference voltage, the gate high voltage, the gate low voltage, etc. In addition, the power circuit 140 may output a constant voltage to be provided to the pixels P. The gamma reference voltage may be supplied to the data driver 110. The gate high voltage VGH and the gate low voltage VGL may be supplied to the level shifter 150 and the gate driver 120. The constant voltages input to the pixel circuit, such as pixel driving voltage, pixel ground voltage, etc., may be applied to the pixels P and the dummy pixels 160 through the power lines commonly connected to the pixels P. The pixel ground voltage EVSS may be the cathode voltage. The power circuit 140 may be implemented as a power IC such as a power management integrated circuit (PMIC), an electronics integrated circuit (ELIC), or the like, but is not limited thereto.

The driving circuits (including the data driver 110 and gate driver 120) of the display panel 100 may be driven at a variable refresh rate (VRR) under the control of the timing controller 130. For example, the timing controller 130 may reduce power consumption of the display device by analyzing the input image and lowering the refresh rate when the input image does not change by a preset amount of time. In this case, the driving circuit of the display panel 100 may lower the refresh rate of the pixels P when a still image is input for a certain period of time or more under the control of the timing controller 130 to control a data writing period of the pixels P to be longer, thereby reducing the power consumption of the display device. The driving circuit of the display panel 100 may reduce the refresh rate when the display device is operated in standby mode or in response to a user command. Further, the refresh rate may be lowered in an always on display (AOD) screen. The AOD screen is a small area of pixels in the display area AA in which preset information, for example, brief information such as remaining battery power, time, and the like are displayed in the standby mode.

The host system 200 may scale an image signal from a video source to match the resolution of the display panel 100, and may transmit it to the timing controller 130 together with the timing control signal.

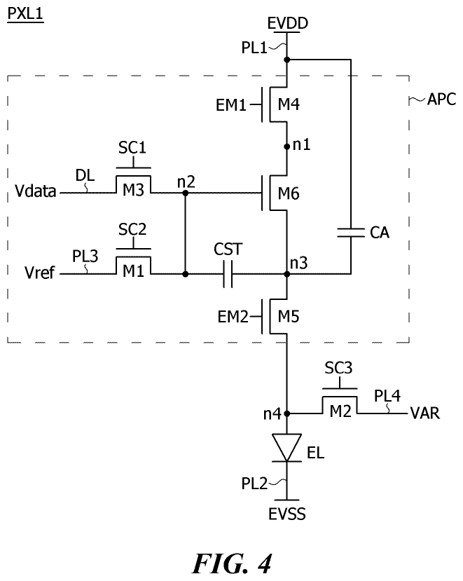

In the case of the pixel circuits shown in FIGS. 4 to 7, the gate signals may include a first scan signal SC1, a second scan signal SC2, a third scan signal SC3, and an emission signal (hereinafter, referred to as “EM signal”). In this case, the gate driver 120 may include a first gate driver that outputs the first scan signal SC1, a second gate driver that outputs the second scan signal SC2, a third gate driver that outputs the third scan signal SC3, and a fourth gate driver that outputs the EM signal. Each of the first to fourth gate drivers may start outputting a pulse of a corresponding gate signal in response to a start pulse, and may shift the pulse in accordance with a shift clock timing.

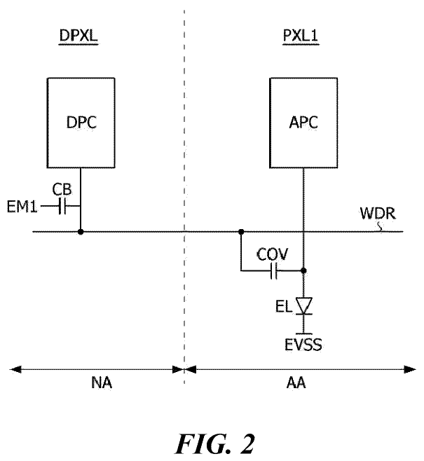

In the manufacturing process of the display panel 100, a defective sub-pixel may occur. For example, a pixel circuit for driving a light-emitting element EL may be driven normally and the defective sub-pixel may appear as a bright spot. In order to repair such a defective sub-pixel, a repair process may electrically connect the defective sub-pixel to a dummy pixel to drive the light-emitting element of the defective sub-pixel. To this end, the display panel 100 may further include a plurality of repair lines WDR, such as those shown in FIG. 2.

The present disclosure may improve the temperature luminous sensitivity (TLS) characteristics of the pixels by rapidly charging an anode voltage of the light-emitting element in the pixels of the display area AA using a gate signal, e.g., a voltage of the EM signal, applied to the dummy pixel through the repair line WDR. Here, the pixels in the display area AA with improved TLS characteristics are all pixels in the display area AA, including pixels that are normally driven and defective sub-pixels.

FIG. 2 is a diagram illustrating an example of a repair line. In FIG. 2, “DPXL” represents one of the dummy pixels shown in FIG. 1, and “PXL1” represents an arbitrary sub-pixel present in the display area AA. “DPC” represents a dummy pixel circuit, and “APC” represents a pixel circuit of the sub-pixel PXL1 positioned in the display area AA.

Referring to FIG. 2, the repair lines WDR may be formed as long wires that extend across the non-display area NA and the display area AA in the Y-axis direction (second direction) in each pixel line of the display panel 100. The repair lines WDR may be parallel to the gate lines 103 and may intersect with the data lines 102 and 104, all of which are shown in FIG. 1.

To improve TLS (Temperature Luminous Sensitivity) characteristics, the dummy pixel circuit DPC formed in the dummy pixel DPXL and the pixel circuit APC of the display area AA may be electrically connected through the repair line WDR and a first compensation capacitor COV. When an emission period of the sub-pixel PXL1 begins, a voltage applied through the dummy pixel circuit DPC of the dummy pixel DPXL may charge the anode electrode of the light-emitting element EL formed in the sub-pixel PXL1 through the repair line WDR and the capacitor COV. The first compensation capacitor COV may be formed by metal layers overlapping each other with an insulating layer (dielectric layer) interposed therebetween at an intersection between the repair line WDR and a node connected to the anode electrode of the light-emitting element EL.

The light-emitting element EL may be implemented as an OLED or an inorganic LED such as a micro LED. The light-emitting element EL may include a capacitor present between an anode electrode and a cathode electrode. The OLED includes an anode electrode, a cathode electrode, and an organic compound layer interposed between these electrodes. The organic compound layer may include a hole injection layer (HIL), a hole transport layer (HTL), a light emission layer (EML), an electron transport layer (ETL), and an electron injection layer (EIL), but is not limited thereto. When a voltage is applied to the anode electrode and the cathode electrode of the light-emitting element EL, holes passing through the hole transport layer (HTL) and electrons passing through the electron transport layer (ETL) move into the light emission layer (EML) to form excitons. At this time, visible light is emitted from the light emission layer (EML). The OLED may be implemented as an OLED having a tandem structure in which a plurality of light emission layers are stacked. The OLED having the tandem structure may improve the luminance and lifetime of a pixel.

The dummy pixel DPXL may further include a second compensation capacitor CB for improving the TLS (Temperature Luminous Sensitivity) characteristics of the sub-pixel PXL1 by transmitting a voltage of an EM signal EM1 to the repair line WDR.

The dummy pixel DPXL does not require a light-emitting element, but may further include a light-emitting element that is omitted from the drawing. The light-emitting element formed in the dummy pixel DPXL may have substantially the same structure as the light-emitting element located in the sub-pixel PXL1 of the display area AA and may be covered by a black matrix.

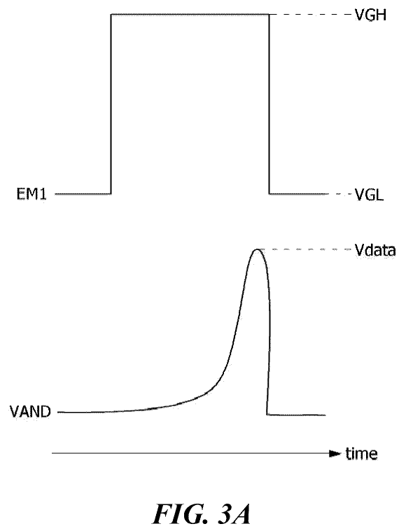

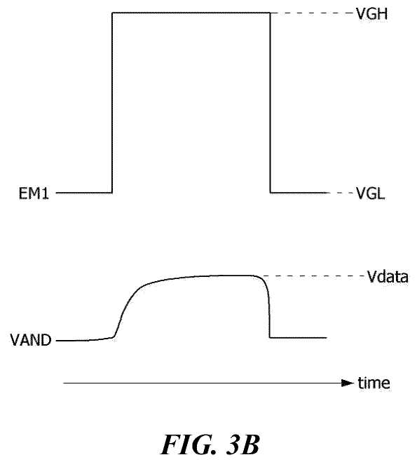

FIGS. 3A and 3B are diagrams for explaining a comparison of TLS (Temperature Luminous Sensitivity) characteristics between an embodiment of the present disclosure and a comparative example. TLS is a characteristic that describes how much brightness changes under a specific temperature condition. TLS refers to how sensitively the luminance of a light-emitting element varies when the temperature of a pixel changes. When TLS is improved, the luminance variation of the light-emitting element according to temperature fluctuation is reduced.

FIG. 3A is a waveform diagram illustrating the EM signal EM1 and an anode voltage VAND of the light-emitting element in a comparative example having poor TLS characteristics. FIG. 3B is a waveform diagram illustrating the EM signal EM1 and the anode voltage VAND of the light-emitting element in an embodiment with improved TLS characteristics. In a VGH section of the EM signal EM1, the anode voltage of the light-emitting element EL may begin to be charged and light emission may occur. In the comparative example shown in FIG. 3A and the embodiment shown in FIG. 3B, it is assumed that the amount of charge in the anode electrode of the light-emitting element is the same.

As shown in FIG. 3A, the anode electrode of the light-emitting element may begin to be charged to a high data voltage Vdata with a delay after the emission period begins. In this case, the slope of the anode voltage during charging is large, which causes the luminance of the light-emitting element EL to vary sensitively according to temperature changes.

As shown in FIG. 3B, the anode electrode of the light-emitting element may begin to be rapidly charged to a low data voltage Vdata immediately after the emission period begins, and may be charged by an amount equal to the charged amount of the comparative example. In this case, the slope of the anode voltage during charging is small. When the slope of the anode voltage is small, the luminance of the light-emitting element does not vary sensitively with temperature changes, and thus TLS characteristics are improved.

In the case of a comparative example such as FIG. 3A, TLS (Temperature Luminous Sensitivity) characteristics may deteriorate when a luminance control value that defines the luminance of a pixel is low. The luminance control value may be a DBV (digital brightness value, display brightness value, or display brightness voltage). The host system may update the DBV in response to ambient illuminance (brightness) by responding to brightness adjustment input data inputted through a user interface or to an output of an illuminance sensor, thereby controlling the luminance of pixels P. The power circuit 140 may adjust a gamma reference voltage in association with the DBV. For example, the power circuit 140 may output a gamma reference voltage of a gamma band indicated by the DBV from among gamma bands classified by luminance, in association with the DBV inputted to a programmable gamma circuit, and may supply the gamma reference voltage to the data driver 110. Since a data voltage outputted from the data driver 110 is determined based on the gamma reference voltage, the luminance of the pixels may vary in association with a change in the DBV.

The present disclosure may improve TLS characteristics and enhance image quality even at a low DBV by enabling the anode electrode of the light-emitting element EL to be charged immediately after the start of the emission period, as shown in FIG. 3B, using a dummy pixel and a repair line.

The pixel circuit of the display area may be implemented using a diode connection-based internal compensation circuit or a source follower-based internal compensation circuit.

FIG. 4 is a circuit diagram illustrating a pixel circuit in a display area according to one embodiment of the present disclosure. FIG. 4 illustrates an example of a pixel circuit to which a diode connection-based internal compensation circuit is applied, but the embodiment of the present disclosure is not limited thereto.

Referring to FIG. 4, the sub-pixel PXL1 of the display area AA includes the pixel circuit APC that drives the light-emitting element EL. The pixel circuit APC includes a driving element M6, a plurality of switch elements M1 to M5, a first capacitor CST, and a second capacitor CA. The driving element M6 and the switch elements M1 to M5 may be implemented as n-channel oxide TFTs, but are not limited thereto.

The pixel circuit APC is connected to a data line DL to which the data voltage Vdata of the pixel data is applied, and gate lines to which gate signals SC1, SC2, SC3, EM1, and EM2 are applied. The pixel circuit APC is connected to a first constant voltage node PL1 to which the pixel driving voltage EVDD is applied, a second constant voltage node PL2 to which the pixel ground voltage EVSS is applied, a third constant voltage node PL3 to which a reference voltage Vref is applied, and a fourth constant voltage node PL4 to which an anode reset voltage VAR is applied. These constant voltage nodes may be connected to corresponding power lines.

The voltage level of each of the constant voltages EVDD, EVSS, Vref, and VAR applied to the pixel circuit APC may be set in consideration of a voltage margin for saturation region operation. The voltage levels of the constant voltages EVDD, EVSS, Vref, and VAR may be set under a condition of EVDD>Vref>VAR>EVSS. The gate high voltage VGH may be set to a voltage higher than the pixel driving voltage EVDD, and the gate low voltage VGL may be set to a voltage lower than the pixel ground voltage EVSS. The data voltage Vdata outputted from the data driver 110 has a dynamic range set between the reference voltage Vref and the pixel driving voltage EVDD. In one example, a lowest value of the data voltage Vdata may be set to a voltage close to the reference voltage Vref, and a highest value of the data voltage Vdata may be set to a voltage close to the pixel driving voltage EVDD. Hereinafter, the gate high voltage VGH will be referred to as a gate-on voltage, and the gate low voltage VGL will be referred to as a gate-off voltage.

The gate signals SC1, SC2, SC3, EM1, and EM2 include pulses that swing between the gate-on voltage VGH and the gate-off voltage VGL.

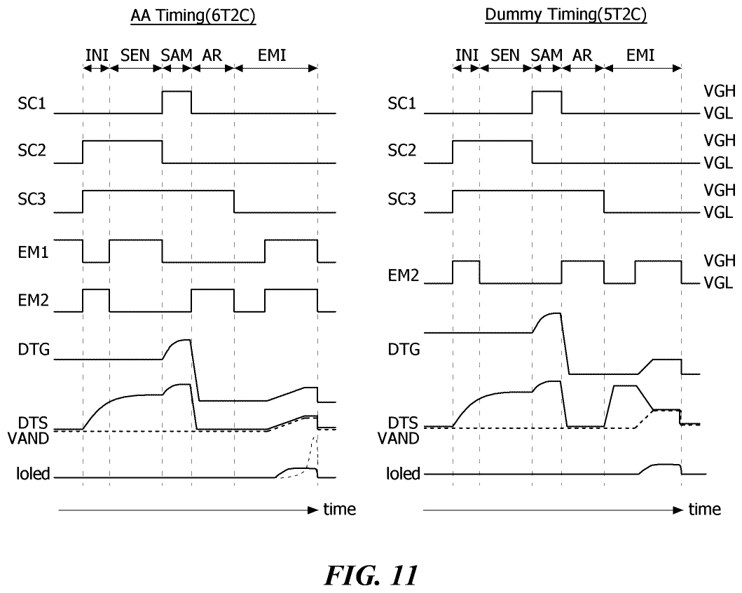

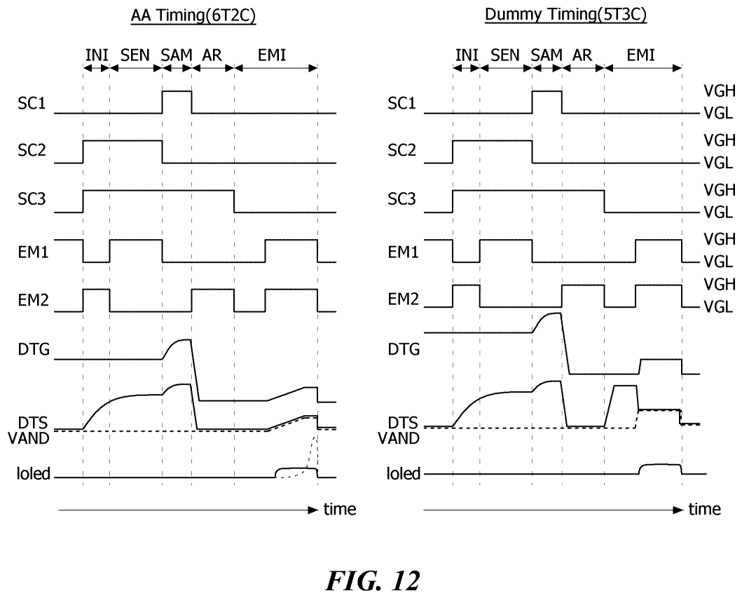

During one frame period, the pixel circuit shown in FIG. 4 may be driven in the order of an initialization period INI, a sensing period SEN, a sampling period SAM, an anode reset period AR, and an emission period EMI, as shown in FIGS. 11 and 12. The initialization period INI, the sensing period SEN, the sampling period SAM, the anode reset period AR, and the emission period EMI may be defined by the waveforms of the gate signals SC1, SC2, SC3, EM1, and EM2. After a voltage at a third node n3 and the anode voltage of the light-emitting element EL rise at the beginning of the emission period EMI, the light-emitting element EL may emit light.

In FIGS. 11 and 12, “AA Timing (6T2C)” represents waveforms of gate signals and major nodes that sequentially show an internal compensation operation of the pixel circuit APC when the pixels of the display area AA are implemented using the pixel circuit APC shown in FIG. 4.

Referring to FIGS. 4, 11, and 12, a voltage of a first EM signal EM1 is the gate-on voltage VGH during the sensing period SEN and the emission period EMI, and is the gate-off voltage VGL during the initialization period INI, the sampling period SAM, and the anode reset period AR. A fourth switch element M4 is turned on in response to the gate-on voltage VGH of the first EM signal EM1 and is turned off in response to the gate-off voltage VGL of the first EM signal EM1.

The voltage of a second EM signal EM2 is the gate-on voltage VGH during the initialization period INI, the anode reset period AR, and the emission period EMI, and is the gate-off voltage VGL during the sensing period SEN and the sampling period SAM. A fifth switch element M5 is turned on in response to the gate-on voltage VGH of the second EM signal EM2 and is turned off in response to the gate-off voltage VGL of the second EM signal EM2.

The voltage of the first scan signal SC1 is generated as a pulse of the gate-on voltage VGH synchronized with the data voltage Vdata of the pixel data during the sampling period SAM, and is the gate-off voltage VGL during the other periods INI, SEN, AR, and EMI. A third switch element M3 is turned on in response to the gate-on voltage VGH of the first scan signal SC1 and is turned off in response to the gate-off voltage VGL of the first scan signal SC1.

The voltage of the second scan signal SC2 is generated as a pulse of the gate-on voltage VGH during the initialization period INI and the sensing period SEN, and is the gate-off voltage VGL during the other periods SAM, AR, and EMI. A first switch element M1 is turned on in response to the gate-on voltage VGH of the second scan signal SC2 and is turned off in response to the gate-off voltage VGL of the second scan signal SC2.

The voltage of the third scan signal SC3 is the gate-on voltage VGH during the initialization period INI, the sensing period SEN, the sampling period SAM, and the anode reset period AR, and is the gate-off voltage VGL during the emission period EMI. A second switch element M2 is turned on in response to the gate-on voltage VGH of the third scan signal SC3 and is turned off in response to the gate-off voltage VGL of the third scan signal SC3.

The driving element M6 generates a current according to a gate-to-source voltage Vgs to drive the light-emitting element EL. The gate-to-source voltage Vgs of the driving element M6 may be a voltage applied between a second node n2 and the third node n3. The driving element M6 includes a first electrode connected to a first node n1, a gate electrode connected to the second node n2, and a second electrode connected to the third node n3.

The anode electrode of the light-emitting element EL may be connected to a fourth node n4, and the cathode electrode thereof may be connected to the second constant voltage node PL2 to which the pixel ground voltage EVSS is applied. The light-emitting element EL includes a capacitor formed between the anode electrode and the cathode electrode.

The first capacitor CST is connected between the second node n2 and the third node n3. The first capacitor CST is initialized during the initialization period INI, and then stores a threshold voltage Vth of the driving element M6 during the sensing period SEN. The first capacitor CST stores the data voltage Vdata of the pixel data compensated by the threshold voltage Vth of the driving element M6 during the sampling period SAM, and then maintains the gate-to-source voltage Vgs of the driving element M6 during the anode reset period AR and the emission period EMI.

The second capacitor CA may be connected between the first constant voltage node PL1 and the third node n3. The second capacitor CA prevents loss of the data voltage Vdata. A transmission rate (Data DR) of the data voltage Vdata is expressed by Equation 1 below:

$$Data DR = 1 - \frac{Cst}{Cst + {C}_{{DTS}_{hold}}} , {C}_{{DTS}_{hold}} = CA + {C}_{DTS \_ par} \qquad Equation 1$$

Here, C_{DTS_par} is a parasitic capacitance connected to the third node n3. As the value of C_{DTShold} increases, the data voltage Vdata is more completely transmitted, and loss of the data voltage Vdata is reduced.

The first switch element M1 is connected between the third constant voltage node PL3 to which the reference voltage Vref is applied and the second node n2, and is turned on in response to the gate-on voltage VGH of the second scan signal SC2. When the first switch element M1 is turned on, the reference voltage Vref is applied to the second node n2. The first switch element M1 is in an off state when a voltage of the second scan signal SC2 is the gate-off voltage VGL. The first switch element M1 includes a first electrode connected to the third constant voltage node PL3, a gate electrode connected to a gate line to which the second scan signal SC2 is applied, and a second electrode connected to the second node n2.

The second switch element M2 is connected between the fourth constant voltage node PL4 to which the anode reset voltage VAR is applied and the fourth node n4, and is turned on in response to the gate-on voltage VGH of the third scan signal SC3. When the second switch element M2 is turned on, the anode reset voltage VAR is applied to the fourth node n4. The second switch element M2 is in an off state when a voltage of the third scan signal SC3 is the gate-off voltage VGL. The second switch element M2 includes a first electrode connected to the fourth constant voltage node PL4, a gate electrode connected to a gate line to which the third scan signal SC3 is applied, and a second electrode connected to the fourth node n4.

The third switch element M3 is connected between the data line DL to which the data voltage Vdata of the pixel data is applied and the second node n2, and is turned on in response to the gate-on voltage VGH of the first scan signal SC1. When the third switch element M3 is turned on, the data voltage Vdata is applied to the second node n2. The third switch element M3 is in an off state when a voltage of the first scan signal SC1 is the gate-off voltage VGL. The third switch element M3 includes a first electrode connected to the data line DL, a gate electrode connected to a gate line to which the first scan signal SC1 is applied, and a second electrode connected to the second node n2.

The fourth switch element M4 is connected between the first constant voltage node PL1 to which the pixel driving voltage EVDD is applied and the first node n1, and is turned on in response to the gate-on voltage VGH of the first EM signal EM1. When the fourth switch element M4 is turned on, the pixel driving voltage EVDD may be applied to the first node n1. The fourth switch element M4 includes a first electrode connected to the first constant voltage node PL1, a gate electrode connected to a gate line to which the first EM signal EM1 is applied, and a second electrode connected to the first node n1.

The fifth switch element M5 is connected between the third node n3 and the fourth node n4, and is turned on in response to the gate-on voltage VGH of the second EM signal EM2. When the fifth switch element M5 is turned on, the third node n3 may be electrically connected to the fourth node n4. The fifth switch element M5 includes a first electrode connected to the third node n3, a gate electrode connected to a gate line to which the second EM signal EM2 is applied, and a second electrode connected to the fourth node n4.

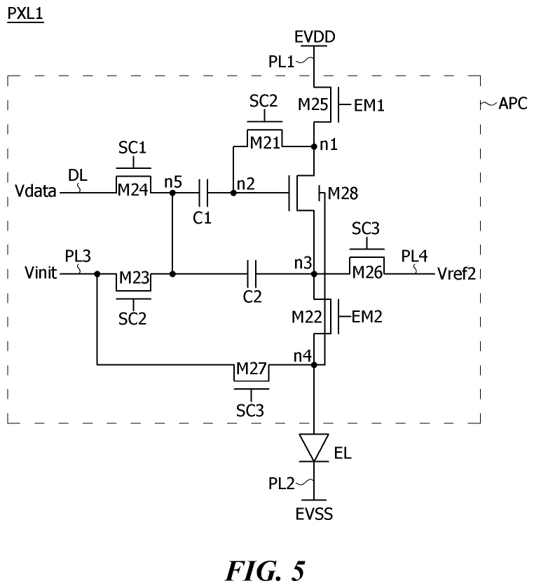

FIG. 5 is a circuit diagram illustrating a pixel circuit in a display area according to another embodiment of the present disclosure. FIG. 5 illustrates an example of a pixel circuit to which a source follower-based internal compensation circuit is applied, but the embodiment of the present disclosure is not limited thereto.

Referring to FIG. 5, the pixel circuit APC includes a driving element M28, a plurality of switch elements M21 to M27, a first capacitor C1, and a second capacitor C2. The driving element M28 and the switch elements M21 to M27 may be implemented as n-channel oxide TFTs, but are not limited thereto.

The pixel circuit APC is supplied with the data voltage Vdata of the pixel data, the gate signals SC1, SC2, SC3, EM1, and EM2, and DC voltages such as the pixel driving voltage EVDD, the pixel ground voltage EVSS, a reference voltage Vref2, and an initialization voltage Vinit. The voltages applied to the pixel circuit APC may be set such that EVDD>Vref2>Vinit>EVSS, but are not limited thereto.

The pixel circuit APC may be driven in the order of an initialization period in which the pixel circuit APC is initialized, a sampling period in which the threshold voltage Vth of the driving element M28 is sampled, an addressing period in which the data voltage Vdata is charged and the pixel data is written, and an emission period in which the light-emitting element EL emits light. Each period may be defined by the gate signals SC1, SC2, SC3, EM1, and EM2.

The anode electrode of the light-emitting element EL is connected to a fourth node n4, and the cathode electrode of the light-emitting element EL may be connected to the second constant voltage node PL2 to which the pixel ground voltage EVSS is applied. The first capacitor C1 is connected between a second node n2 and a fifth node n5. The second capacitor C2 is connected between a third node n3 and the fifth node n5.

The driving element M28 may be a transistor having a double gate structure. The driving element M28 includes a first gate electrode connected to the second node n2, a second gate electrode connected to the fourth node n4, a first electrode connected to a first node n1, and a second electrode connected to the third node n3.

The switch elements M21 to M27 are turned on in response to the gate-on voltage of a gate signal applied to their respective gate electrodes and are turned off in response to a gate-off voltage.

A first switch element M21 is turned on in response to the gate-on voltage VGH of the second scan signal SC2 during the initialization period and the sampling period, and may electrically connect the first node n1 to the second node n2. The first switch element M21 includes a first electrode connected to the first node n1, a second electrode connected to the second node n2, and a gate electrode connected to a gate line to which the second scan signal SC2 is applied.

A second switch element M22 is turned on in response to the gate-on voltage VGH of the second EM signal EM2 during the emission period, and may form a current path between the driving element M28 and the light-emitting element EL. The second switch element M22 includes a first electrode connected to the third node n3, a second electrode connected to the fourth node n4, and a gate electrode connected to a gate line to which the second EM signal EM2 is applied.

A third switch element M23 is turned on in response to the gate-on voltage VGH of the second scan signal SC2 during the initialization period and the sampling period, and may supply the initialization voltage Vinit to the fifth node n5. The third switch element M23 includes a first electrode connected to the third constant voltage node PL3 to which the initialization voltage Vinit is applied, a second electrode connected to the fifth node n5, and a gate electrode connected to a gate line to which the second scan signal SC2 is applied.

A fourth switch element M24 is turned on in response to the gate-on voltage VGH of the first scan signal SC1 during the addressing period, and may supply the data voltage Vdata to the fifth node n5. The fourth switch element M24 includes a first electrode connected to the data line DL to which the data voltage Vdata is applied, a second electrode connected to the fifth node n5, and a gate electrode connected to a gate line to which the first scan signal SC1 is applied.

A fifth switch element M25 is turned on in response to the gate-on voltage VGH of the first EM signal EM1 during the initialization period and the emission period, and may supply the pixel driving voltage EVDD to the first node n1. The fifth switch element M25 includes a first electrode connected to the first constant voltage node PL1 to which the pixel driving voltage EVDD is applied, a second electrode connected to the first node n1, and a gate electrode connected to a gate line to which the first EM signal EM1 is applied.

A sixth switch element M26 is turned on in response to the gate-on voltage VGH of the third scan signal SC3 during the sampling period and the addressing period, and may supply the reference voltage Vref2 to the third node n3. The sixth switch element M26 includes a first electrode connected to the third node n3, a second electrode connected to the fourth constant voltage node PL4 to which the reference voltage Vref2 is applied, and a gate electrode connected to a gate line to which the third scan signal SC3 is applied.

A seventh switch element M27 is turned on in response to the gate-on voltage VGH of the third scan signal SC3 during the sampling period and the addressing period, and may supply the initialization voltage Vinit to the fourth node n4. The seventh switch element M27 includes a first electrode connected to the third constant voltage node PL3 to which the initialization voltage Vinit is applied, a second electrode connected to the fourth node n4, and a gate electrode connected to a gate line to which the third scan signal SC3 is applied.

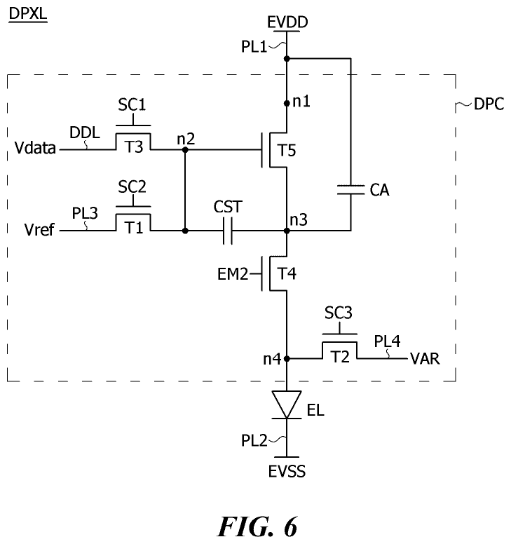

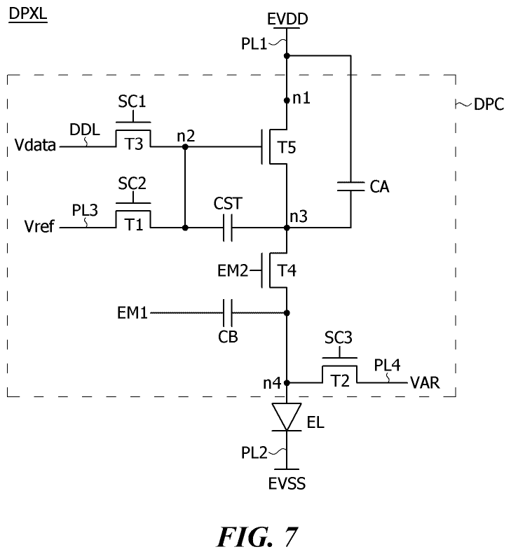

The dummy pixel DPXL includes a pixel circuit capable of supplying a voltage to the repair line WDR during the emission period in which the sub-pixels of the display area AA emit light. As shown in FIGS. 6 and 7, the dummy pixel DPXL may be implemented as a pixel circuit in which the fourth switch element M4 is removed from the pixel circuit of the display area AA shown in FIG. 4, so that the third node n3 and the anode electrode of the light-emitting element EL may be rapidly charged.

FIG. 6 is a circuit diagram illustrating the dummy pixel circuit DPC of the dummy pixel DPXL according to one embodiment of the present disclosure. In FIG. 6, redundant descriptions with the pixel circuit shown in FIG. 4 are omitted.

Referring to FIG. 6, the dummy pixel circuit DPC shares the gate signals SC1, SC2, SC3, and EM2 except for the first EM signal EM1, and shares the constant voltages EVDD, EVSS, Vref, and VAR.

The dummy pixel circuit DPC includes a driving element T5, a plurality of switch elements T1 to T4, the first capacitor CST, and the second capacitor CA. The driving element T5 and the switch elements T1 to T4 may be implemented as n-channel oxide TFTs, but are not limited thereto. The switch elements T1 to T4 may be turned on in response to the gate-on voltage VGH of the corresponding gate signals SC1, SC2, SC3, and EM2, and may be turned off in response to the gate-off voltage VGL.

The dummy pixel circuit DPC is connected to a dummy data line DDL to which the data voltage Vdata of the pixel data is applied, and to gate lines to which the gate signals SC1, SC2, SC3, and EM2 are applied. While the pixel circuit shown in FIG. 4 includes a switch element for applying the first EM signal EM1, the switch element for applying the first EM signal EM1 is removed in the pixel circuit of the dummy pixel. This is to improve TLS characteristics by rapidly charging the third node n3 and the anode electrode of the light-emitting element EL during the emission period.

During one frame period, similarly to the pixel circuit APC shown in FIG. 4, the dummy pixel circuit DPC shown in FIG. 6 may be driven in the order of the initialization period INI, the sensing period SEN, the sampling period SAM, the anode reset period AR, and the emission period EMI, as shown in FIG. 11. The initialization period INI, the sensing period SEN, the sampling period SAM, the anode reset period AR, and the emission period EMI may be defined by the waveforms of the gate signals SC1, SC2, SC3, and EM2.

In FIG. 11, “Dummy Timing (5T2C)” represents waveforms of the gate signals and major nodes that sequentially show an internal compensation operation of the dummy pixel circuit DPC when the dummy pixel DPXL is implemented using the dummy pixel circuit DPC shown in FIG. 6.

Referring to FIGS. 6 and 11, the driving element T5 includes a first electrode connected to the first node n1, a gate electrode connected to the second node n2, and a second electrode connected to the third node n3. The first node n1 is directly connected to the first constant voltage node PL1. The pixel driving voltage EVDD is directly applied to the first node n1.

The anode electrode of the light-emitting element EL may be connected to the fourth node n4, and the cathode electrode thereof may be connected to the second constant voltage node PL2 to which the pixel ground voltage EVSS is applied. The light-emitting element EL includes a capacitor formed between the anode electrode and the cathode electrode.

The first capacitor CST is connected between the second node n2 and the third node n3. The second capacitor CA is connected between the first constant voltage node PL1 and the third node n3.

A first switch element T1 is connected between the third constant voltage node PL3 and the second node n2, and is turned on in response to the gate-on voltage VGH of the second scan signal SC2 during the initialization period INI and the sensing period SEN. When the first switch element T1 is turned on, the reference voltage Vref is applied to the second node n2. The first switch element T1 is in an off state during the sampling period SAM, the anode reset period AR, and the emission period EMI, in which a voltage of the second scan signal SC2 is the gate-off voltage VGL. The first switch element T1 includes a first electrode connected to the third constant voltage node PL3, a gate electrode connected to a gate line to which the second scan signal SC2 is applied, and a second electrode connected to the second node n2.

A second switch element T2 is connected between the fourth constant voltage node PL4 and the fourth node n4, and is turned on in response to the gate-on voltage VGH of the third scan signal SC3 during the initialization period INI, the sensing period SEN, the sampling period SAM, and the anode reset period AR. When the second switch element T2 is turned on, the anode reset voltage VAR is applied to the fourth node n4. The second switch element T2 is in an off state during the emission period EMI, in which a voltage of the third scan signal SC3 is the gate-off voltage VGL. The second switch element T2 includes a first electrode connected to the fourth constant voltage node PL4, a gate electrode connected to a gate line to which the third scan signal SC3 is applied, and a second electrode connected to the fourth node n4.

A third switch element T3 is connected between the dummy data line DDL to which the data voltage Vdata is applied and the second node n2. The third switch element T3 is turned on in response to the gate-on voltage VGH of the first scan signal SC1 during the sampling period SAM. When the third switch element T3 is turned on, the data voltage Vdata is applied to the second node n2. The third switch element T3 is in an off state during the initialization period INI, the sensing period SEN, the anode reset period AR, and the emission period EMI, in which a voltage of the first scan signal SC1 is the gate-off voltage VGL. The third switch element T3 includes a first electrode connected to the dummy data line DDL, a gate electrode connected to a gate line to which the first scan signal SC1 is applied, and a second electrode connected to the second node n2.

A fourth switch element T4 is connected between the third node n3 and the fourth node n4, and is turned on in response to the gate-on voltage VGH of the second EM signal EM2 during the initialization period INI, the anode reset period AR, and the emission period EMI. When the fourth switch element T4 is turned on, the third node n3 may be electrically connected to the fourth node n4. The fourth switch element T4 is in an off state during the sensing period SEN and the sampling period SAM, in which a voltage of the second EM signal EM2 is the gate-off voltage VGL. The fourth switch element T4 includes a first electrode connected to the third node n3, a gate electrode connected to a gate line to which the second EM signal EM2 is applied, and a second electrode connected to the fourth node n4.

FIG. 7 is a circuit diagram illustrating the dummy pixel circuit DPC of the dummy pixel DPXL according to another embodiment of the present disclosure. In FIG. 7, redundant descriptions with the pixel circuits shown in FIGS. 4 and 6 are omitted.

The dummy pixel circuit DPC shown in FIG. 7 further includes the second compensation capacitor CB.

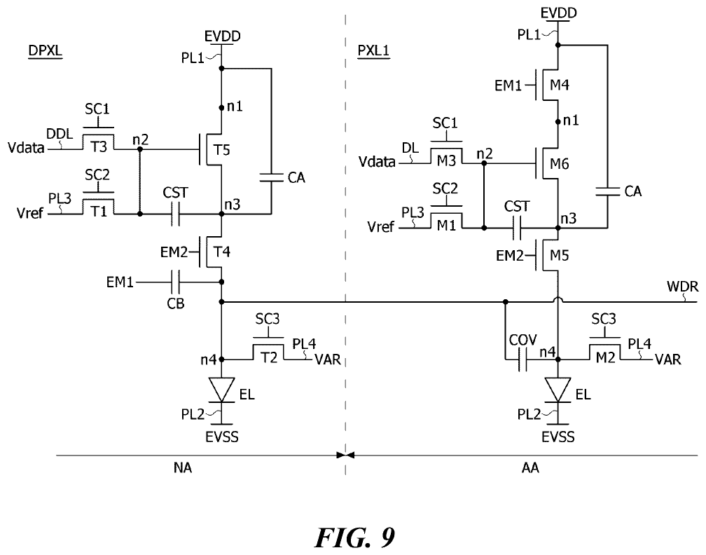

The second compensation capacitor CB is connected between a gate line to which the first EM signal EM1 is applied and the fourth node n4 of the dummy pixel circuit DPC. As shown in FIG. 9, the fourth node n4 is connected to the repair line WDR. Accordingly, the second compensation capacitor CB is connected to the repair line WDR by capacitor coupling. The second compensation capacitor CB may transmit a voltage of the first EM signal EM1 to the pixels P of the display area through the repair line WDR to rapidly charge the anode electrodes of the light-emitting elements EL and improve TLS characteristics. The first EM signal EM1 is applied with the same waveform to the pixel circuit APC of the display area AA and the dummy pixel circuit DPC of the dummy pixel DPXL. Accordingly, as shown in FIGS. 7 and 11, a voltage of the first EM signal EM1 is activated to the gate-on voltage VGH during the sensing period SEN and the emission period EMI, and is deactivated to the gate-off voltage VGL during the initialization period INI, the sampling period SAM, and the anode reset period AR.

The second compensation capacitor CB may be determined experimentally. The capacitance of the second compensation capacitor CB may be approximately 10% to 100% of the capacitance of the first capacitor CST. The second compensation capacitor CB may have a capacitance of about 10% of that of the first capacitor CST, but is not limited thereto. When the capacitance of the first capacitor CST is in a range of 100 fF to 300 fF, the capacitance of the second compensation capacitor CB may be in a range of 10 fF to 30 fF.

The data voltage Vdata applied to the dummy pixel circuit DPC of the dummy pixel DPXL may be set in consideration of both the TLS characteristics improvement effect and whether a defective sub-pixel is present. In the case of the dummy pixel DPXL connected to a defective sub-pixel through the repair line WDR, the data voltage Vdata applied to the defective sub-pixel may be applied to the dummy pixel circuit DPC of the dummy pixel DPXL.

In the case of a pixel line without a defective sub-pixel, the data voltage Vdata may not be applied to the dummy pixel DPXL, since a voltage of the first EM signal EM1 may be applied to the repair line WDR in the dummy pixel circuit DPC shown in FIG. 7.

In another embodiment for a pixel line without a defective sub-pixel, the data voltage Vdata may be applied to the dummy pixel circuit DPC shown in FIGS. 6 and 7. Due to the resistance of the repair line WDR and the first compensation capacitor COV, an RC load in the pixels of the display area AA may increase, thereby increasing RC delay. In consideration of this, the data voltage Vdata applied to the dummy pixel circuit DPC may be set to the highest voltage of the dynamic range, for example, to a peak white grayscale voltage, in order to reduce RC delay, but is not limited thereto. For example, the data voltage Vdata applied to the dummy pixel DPXL that is electrically connected through a capacitor to the sub-pixels of the pixel line without a defective sub-pixel may be the highest voltage of the data voltage applied to the sub-pixels of the corresponding pixel line, the average voltage, or an experimentally determined voltage.

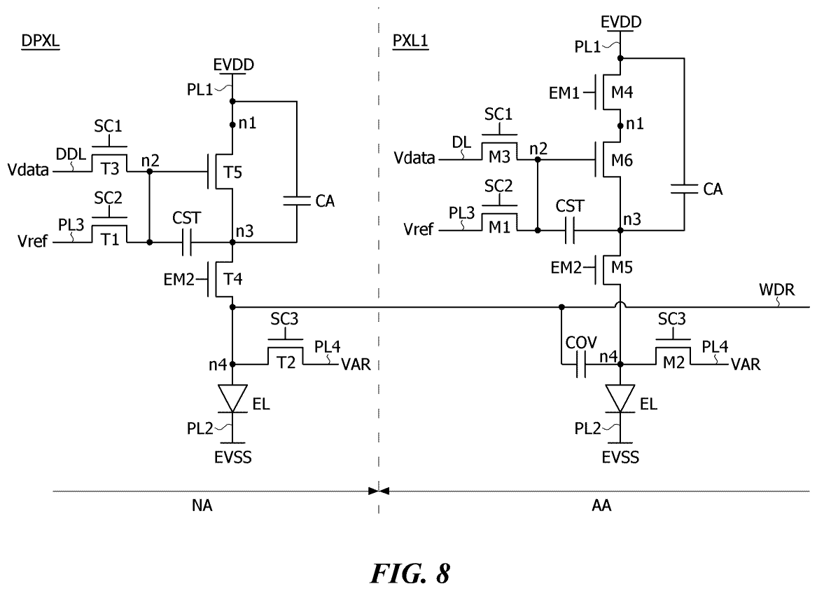

FIG. 8 is a circuit diagram illustrating an example in which the dummy pixel circuit DPC shown in FIG. 6 is electrically connected to the pixel circuit APC shown in FIG. 4 through the repair line WDR and the first compensation capacitor COV. FIG. 9 is a circuit diagram illustrating an example in which the dummy pixel circuit DPC shown in FIG. 7 is electrically connected to the pixel circuit APC shown in FIG. 4 through the repair line WDR and the first compensation capacitor COV. In FIGS. 8 and 9, “PXL1” represents an arbitrary sub-pixel that can be normally driven in the display area AA. Hereinafter, “PXL1” is referred to as “first sub-pixel.”

Referring to FIGS. 8 and 9, the first sub-pixel PXL1 and the dummy pixel DPXL may be driven by sharing the same gate lines and power lines.

The repair line WDR is connected to the fourth node n4 of the dummy pixel DPXL. The fourth node n4 of the first sub-pixel PXL1 is connected to the repair line WDR through the first compensation capacitor COV. The fourth node n4 of the first sub-pixel PXL1 is not directly connected to the repair line WDR.

The third node n3 of the dummy pixel DPXL is pre-charged before the emission period by a current flowing through the driving element T5, and the fourth node n4 is rapidly charged through the fourth switch element T4, which is turned on at the beginning of the emission period. A voltage charged in the fourth node n4 of the dummy pixel DPXL is applied to the fourth node n4 of the first sub-pixel PXL1 through the first compensation capacitor COV. Accordingly, since the anode voltage of the light-emitting element EL in the first sub-pixel PXL1 begins to be rapidly charged at the beginning of the emission period, TLS characteristics are improved.

As shown in FIG. 9, when a voltage of the first EM signal EM1 is applied to the repair line WDR through the second compensation capacitor CB in the dummy pixel DPXL, the anode voltage of the first sub-pixel PXL1 may rise more rapidly at the beginning of the emission period, as shown in FIG. 12.

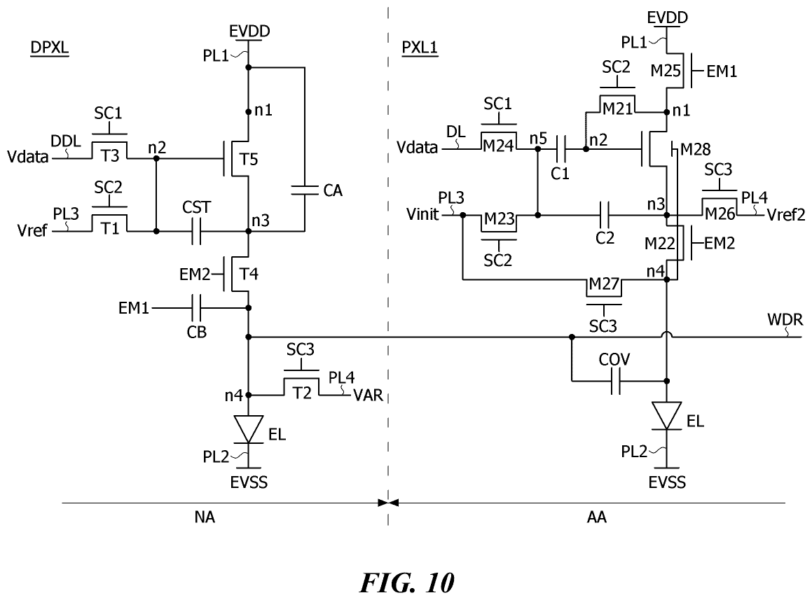

FIG. 10 is a circuit diagram illustrating an example in which the dummy pixel circuit DPC shown in FIG. 7 is electrically connected to the pixel circuit APC shown in FIG. 5 through the repair line WDR and the first compensation capacitor COV. In this embodiment, since internal compensation driving timings of the dummy pixel DPXL and the first sub-pixel PXL1 may differ, gate lines may not be shared between the first sub-pixel PXL1 and the dummy pixel DPXL, and a gate driver may be additionally designed. Due to the connection structure of the dummy pixel DPXL and the first sub-pixel PXL1 shown in FIG. 10, a voltage charged in the fourth node n4 of the dummy pixel DPXL is applied to the fourth node n4 of the first sub-pixel PXL1 through the first compensation capacitor COV at the beginning of the emission period, so that the anode voltage of the light-emitting element EL is rapidly charged and TLS characteristics are improved.

FIG. 11 is a waveform diagram illustrating gate signals applied to the pixel circuits shown in FIG. 8 and voltages of major nodes. FIG. 12 is a waveform diagram illustrating gate signals applied to the pixel circuits shown in FIG. 9 and voltages of major nodes. In FIGS. 11 and 12, “DTG” denotes a voltage of the second node n2, “DTS” denotes a voltage of the third node n3, and “VAND” denotes an anode voltage of the light-emitting element EL. The waveform of the third node voltage DTS is shown as a solid line, and the waveform of the anode voltage VAND is shown as a dotted line.

Referring to FIGS. 8, 9, 11, and 12, when the emission period EMI begins, the EM signals EM1 and EM2 rise to the gate-on voltage VGH, thereby turning on the switch elements M4, M5, and T4 between the pixel driving voltage EVDD and the pixel ground voltage EVSS. At this time, a current from the driving element M6 is applied to the anode electrode of the light-emitting element EL formed in the first sub-pixel PXL1, and simultaneously, a current from the dummy pixel DPXL is applied through the repair line WDR, so that the anode voltage VAND of the light-emitting element EL rapidly rises immediately after the emission period EMI begins. As a result, compared to the comparative example indicated by the dotted line, the anode voltage VAND may rise more rapidly with a small slope, thereby improving TLS characteristics.

In a repair process of the display panel, the pixel circuit APC of a defective sub-pixel may be disconnected from the anode electrode of the light-emitting element EL, and the dummy pixel DPXL may be connected to the anode electrode of the light-emitting element EL formed in the defective sub-pixel through the repair line WDR. Accordingly, the light-emitting element of the defective sub-pixel may be normally driven by a current generated from the dummy pixel DPXL.

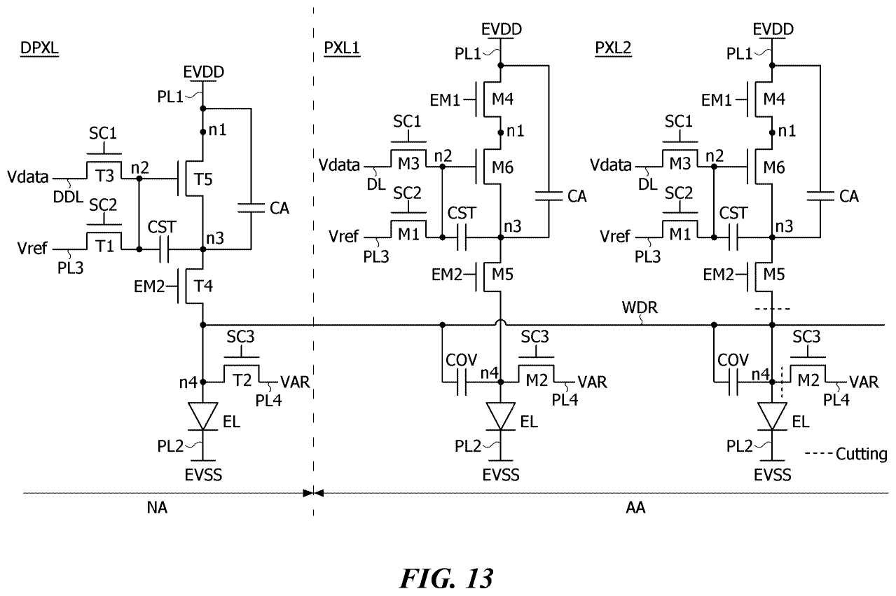

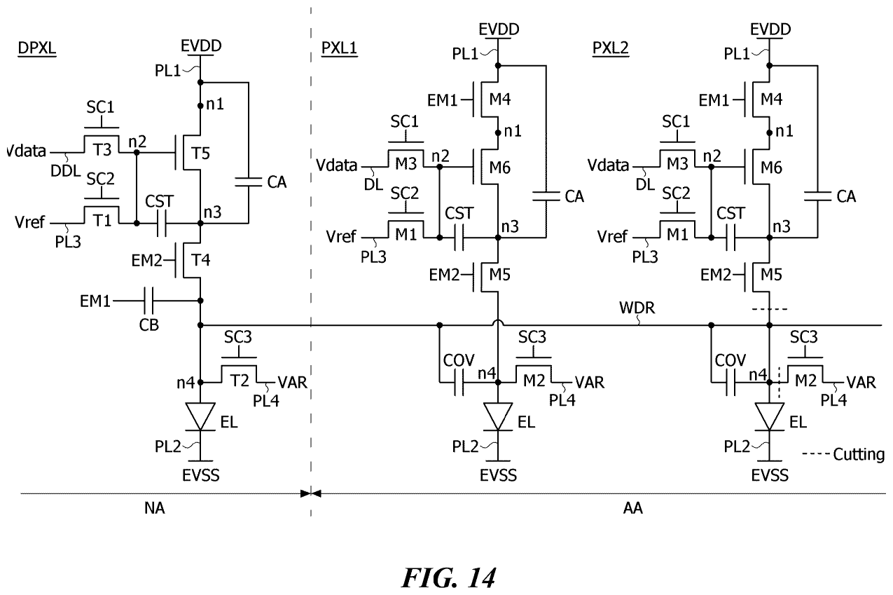

FIG. 13 is a circuit diagram illustrating an example in which a defective sub-pixel is connected to the dummy pixel through a repair line, together with the pixel circuits shown in FIG. 8. FIG. 14 is a circuit diagram illustrating an example in which a defective sub-pixel is connected to a dummy pixel through a repair line, together with the pixel circuits shown in FIG. 9. In FIGS. 13 and 14, “PXL1” denotes the first sub-pixel located in the display area AA and normally driven, and “PXL2” denotes a defective sub-pixel (hereinafter referred to as “second sub-pixel”) located in the display area AA. A dotted straight line indicated in the second sub-pixel PXL2 represents a disconnection position where a wiring is cut by a laser beam during the repair process. In the repair process, a laser beam of a preset wavelength may be irradiated to a desired position in the defective sub-pixel to disconnect a wire (or node) by cutting or to short-circuit it by welding.

Referring to FIGS. 13 and 14, the light-emitting element EL of the second sub-pixel PXL2 is electrically disconnected from the second and fifth switch elements M2 and M5. The fourth node n4 of the second sub-pixel PXL2 is connected to the repair line WDR.

When the dummy pixel DPXL is driven, a current generated from the driving element T5 may flow through the repair line WDR to the light-emitting element EL formed in the second sub-pixel PXL2, so that the light-emitting element EL may be driven. The data voltage Vdata applied to the dummy pixel DPXL is the data voltage to be applied to the second sub-pixel PXL2.

According to one or more embodiments of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display device according to one or more embodiments of the present disclosure may be applied to organic light emitting lighting devices or inorganic light emitting lighting devices.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display panel comprising:
a display area including a plurality of sub-pixels, each of the plurality of sub-pixels including a pixel circuit connected to a light-emitting element;
a non-display area including a plurality of dummy pixels, each of the plurality of dummy pixels including a dummy pixel circuit;
at least one repair line extending across the display area and the non-display area; and
a first compensation capacitor connected between the repair line and an anode electrode of the light-emitting element.

2. The display panel of claim 1, wherein the pixel circuit in the display area includes a diode connection-based internal compensation circuit or a source follower-based internal compensation circuit.

3. The display panel of claim 1, wherein the pixel circuit of each of the sub-pixels in the display area includes:
a driving transistor including a first electrode connected to a first node of the sub-pixel, a gate electrode connected to a second node of the sub-pixel, and a second electrode connected to a third node of the sub-pixel;
a first switch transistor connected between a first constant voltage node configured to receive a reference voltage and the second node of the sub-pixel, and configured to be turned on in response to a second scan signal;
a second switch transistor connected between a second constant voltage node configured to receive an anode reset voltage and a fourth node of the sub-pixel, and configured to be turned on in response to a third scan signal;
a third switch transistor connected between a data line configured to receive a data voltage and the second node of the sub-pixel, and configured to be turned on in response to a first scan signal;
a fourth switch transistor connected between a third constant voltage node configured to receive a pixel driving voltage and the first node of the sub-pixel, and configured to be turned on in response to a first emission signal; and
a fifth switch transistor connected between the third node of the sub-pixel and the fourth node of the sub-pixel, and configured to be turned on in response to a second emission signal.

4. The display panel of claim 3, wherein the pixel circuit of each of the sub-pixels arranged in the display area further includes:
a first capacitor connected between the second node of the sub-pixel and the third node of the sub-pixel; and
a second capacitor connected between the third constant voltage node and the third node of the sub-pixel, and
the anode electrode of the light-emitting element is connected to the fourth node of the sub-pixel, and a cathode electrode of the light-emitting element is connected to a fourth constant voltage node configured to receive a pixel ground voltage.

5. The display panel of claim 3, wherein the dummy pixel circuit includes:
a driving transistor of the dummy pixel including a first electrode connected to a first node of the dummy pixel configured to receive the pixel driving voltage is applied, a gate electrode connected to a second node of the dummy pixel, and a second electrode connected to a third node of the dummy pixel;
a first switch transistor of the dummy pixel connected between the first constant voltage node and the second node of the dummy pixel, and configured to be turned on in response to the second scan signal;
a second switch transistor of the dummy pixel connected between the second constant voltage node and a fourth node of the dummy pixel, and configured to be turned on in response to the third scan signal;
a third switch transistor of the dummy pixel connected between a dummy data line and the second node of the dummy pixel, and configured to be turned on in response to the first scan signal; and
a fourth switch transistor of the dummy pixel connected between the third node of the dummy pixel and the fourth node of the dummy pixel, and configured to be turned on in response to the second emission signal.

6. The display panel of claim 5, wherein the dummy pixel circuit further includes:
a first capacitor of the dummy pixel connected between the second node of the dummy pixel and the third node of the dummy pixel; and
a second capacitor of the dummy pixel connected between the first node of the dummy pixel and the third node of the dummy pixel.

7. The display panel of claim 6, wherein the dummy pixel further includes:
a light-emitting element of the dummy pixel connected between the fourth node of the dummy pixel and a fourth constant voltage node to which a pixel ground voltage is applied.

8. The display panel of claim 5, wherein the dummy pixel circuit further includes:
a second compensation capacitor connected between a gate line to which the first emission signal is applied and the fourth node of the dummy pixel.

9. The display panel of claim 8, wherein the capacitance of the second compensation capacitor CB is 10% to 100% of the capacitance of the first capacitor.

10. The display panel of claim 5, wherein:
the repair line is connected to the fourth node of the dummy pixel, and
the first compensation capacitor is connected between the repair line and the fourth node of the sub-pixel.

11. The display panel of claim 5, wherein a highest voltage of the data voltage is applied to the dummy data line.

12. The display panel of claim 11, wherein:
the display area includes a second sub-pixel,
a pixel circuit of the second sub-pixel is electrically disconnected from an anode electrode of a light-emitting element arranged in the second sub-pixel, and
the anode electrode of the light-emitting element arranged in the second sub-pixel is connected to the repair line.

13. The display panel of claim 12, wherein one of a highest voltage of the data voltage, a data voltage to be applied to the second sub-pixel, or a preset voltage is applied to the dummy data line.

14. A display device comprising:
a display panel including:
a display area having a plurality of sub-pixels, each of the plurality of sub-pixels including a pixel circuit connected to a light-emitting element,
a non-display area having a plurality of dummy pixels, each of the plurality of dummy pixels including a dummy pixel circuit,
at least one repair line extending across the display area and the non-display area, and
a first compensation capacitor connected between the repair line and an anode electrode of the light-emitting element; and
a display panel driving circuit configured to drive the sub-pixels and the dummy pixel.

15. The display device of claim 14, wherein the display panel further includes:
a plurality of data lines connected to the sub-pixels, a dummy data line connected to the dummy pixel, a plurality of gate lines intersecting the data lines and the dummy data line, and a plurality of power lines connected to the sub-pixels and the dummy pixel, and
wherein the sub-pixels and the dummy pixel share the gate lines and the power lines.

16. The display device of claim 15, wherein the display panel driving circuit includes:
a gate driving circuit arranged in the non-display area of the display panel and configured to supply a gate signal to the gate lines; and
a data driving circuit configured to supply a data voltage to the data lines and the dummy data line.

17. The display device of claim 14, wherein the pixel circuit of each of the sub-pixels arranged in the display area includes:
a driving transistor including a first electrode connected to a first node of the sub-pixel, a gate electrode connected to a second node of the sub-pixel, and a second electrode connected to a third node of the sub-pixel;
a first switch transistor connected between a first constant voltage node configured to receive a reference voltage and the second node of the sub-pixel, and configured to be turned on in response to a second scan signal;
a second switch transistor connected between a second constant voltage node configured to receive an anode reset voltage and a fourth node of the sub-pixel, and configured to be turned on in response to a third scan signal;
a third switch transistor connected between a data line configured to receive a data voltage and the second node of the sub-pixel, and configured to be turned on in response to a first scan signal;
a fourth switch transistor connected between a third constant voltage node configured to receive a pixel driving voltage and the first node of the sub-pixel, and configured to be turned on in response to a first emission signal; and
a fifth switch transistor connected between the third node of the sub-pixel and the fourth node of the sub-pixel, and configured to be turned on in response to a second emission signal.

18. The display device of claim 17, wherein the dummy pixel circuit includes:
a driving transistor of the dummy pixel including a first electrode connected to a first node of the dummy pixel configured to receive the pixel driving voltage, a gate electrode connected to a second node of the dummy pixel, and a second electrode connected to a third node of the dummy pixel;
a first switch transistor of the dummy pixel connected between the first constant voltage node and the second node of the dummy pixel, and configured to be turned on in response to the second scan signal;
a second switch transistor of the dummy pixel connected between the second constant voltage node and a fourth node of the dummy pixel, and configured to be turned on in response to the third scan signal;
a third switch transistor of the dummy pixel connected between a dummy data line and the second node of the dummy pixel, and configured to be turned on in response to the first scan signal; and
a fourth switch transistor of the dummy pixel connected between the third node of the dummy pixel and the fourth node of the dummy pixel, and configured to be turned on in response to the second emission signal.

19. The display device of claim 18, wherein the dummy pixel circuit further includes:
a second compensation capacitor connected between a gate line configured to receive the first emission signal and the fourth node of the dummy pixel.

20. The display device of claim 19, wherein:
the repair line is connected to the fourth node of the dummy pixel,
the first compensation capacitor is connected between the repair line and the fourth node of the sub-pixel, and
a highest voltage of the data voltage is applied to the dummy data line.
